(19) United States
(12) Patent Application Publication
(10) Pub. No.: US 2008/0301731 A1
(43) Pub. Date: Dec. 4, 2008

(54) Data Processing Apparatus and Data Processing Method

(75) Inventors: Kiyokazu Yamanaka, Hyogo (JP); Hideyuki Ninomiya, Osaka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 11/793,656

(22) PCT Filed: Dec. 22, 2005
(86) PCT No.: PCT/JP05/24184

§ 371 Date: Jun. 21, 2007

(30) Foreign Application Priority Data
Dec. 24, 2004 (JP) 2004-372805

(51) Int. Cl. H04N 5/445

(52) U.S. Cl. 725/39

(57) ABSTRACT

A data processing apparatus for generating a screen image includes an obtaining section (75) operable to obtain externally data for generating a screen image, a first data storage section (80) operable to store the obtained data, a determination section (30) operable to determine whether a request for power on or standby of the apparatus is issued or not, a generation section (60) operable to generate a screen image by using the data stored in the first data storage section when it is determined by the determination section that the request for standby of the apparatus is issued, and a second storage section (50) operable to store the screen image generated by the generation section.

### TECHNICAL FIELD

The present invention relates to a data processing apparatus which obtains program information from a broadcasting signal, the Internet, or the like, and generates a program guide to display it on a screen.

### BACKGROUND ART

Recently an apparatus which obtains the program information from the broadcasting signal or the Internet, during power off and generates a program guide (EPG: Electric Program Guide) after power on to display the program guide on the screen based on the obtained program information is in widespread use in broadcasting receivers and recorders. Patent Document 1 can be cited as an example.

Patent Document 1: JP 2003-163854, A

### DISCLOSURE OF INVENTION

Recently, because of expansion of functionality of the broadcasting receivers and recorders, it takes several tens seconds to start up the apparatus from the power off state. This is because it is necessary that various processes such as loading of predetermined software and discrimination of drive be performed when the power is turned on during the power off state.

Therefore, in the broadcasting receivers and recorders, it takes at least several tens seconds to display the program guide since a power on operation is performed. As a result, even if a user wants to browse the program guide or to program a timer recording for a short time, the user has to wait for several tens seconds to start up the apparatus. Hence, sometimes the user gets frustrated in browsing the program guide or in programming the timer recording.

The invention is directed to solve the above problems and hence has an object to provide a data processing apparatus which can rapidly browse the program guide in starting up the apparatus.

In a first aspect of the invention, a data processing apparatus for generating a screen image is provided. The apparatus includes an obtaining section operable to obtain externally data for generating a screen image, a first data storage section operable to store the obtained data, a determination section operable to determine whether a request for power on or standby of the apparatus is issued or not to the apparatus, a generation section operable to generate a screen image by using the data stored in the first data storage section when it is determined by the determination section that the request for standby of the apparatus is issued, and a second storage section operable to store the screen image generated by the generation section.

According to this configuration, the screen image can be generated and stored during standby state of the apparatus, and thus when the standby is released the stored screen image can be used immediately for display.

In a second aspect of the invention, a data processing apparatus for generating a screen image is provided. The apparatus includes an obtaining section operable to obtain externally data for generating a screen image, a first data storage section operable to store the obtained data, a measurement section operable to measure time, a determination section operable to determine whether the time measured by the measurement section is a predetermined time, a generation section operable to generate a screen image by using the data stored in the first data storage section when it is determined by the determination section that the time is a predetermined time, and a second storage section operable to store the screen image generated by the generation section.

According to this configuration, the screen image stored can be updated to be the latest every predetermined time, and thus when display of the screen image is requested the latest screen image can be used immediately for display.

The above data processing apparatus may further include a display device operable to display the screen image, a second determination section operable to determine whether a request for display of screen image is issued to the apparatus, a third determination section operable to determine power state of the apparatus when it is determined by the second determination section that the request for display of screen image is issued, and a controller operable to display, on the display device, the screen image stored in the second storage section when it is determined by the third determination section that the power state of the apparatus is standby state.

In a third aspect of the invention, a data processing method for an apparatus for generating a screen image is provided. The data processing method includes the steps of obtaining externally data for generating a screen image, storing the obtained data in a first storage section, determining whether a request for power on or standby of the apparatus is issued to the apparatus or not, generating a screen image by using the data stored in the first data storage section when it is determined that the request for standby of the apparatus is issued, and storing the generated screen image in a second storage section.

In a fourth aspect of the invention, a data processing method for an apparatus for generating a screen image is provided. The data processing method includes the steps of obtaining externally data for generating a screen image, storing the obtained data in a first data storage section, measuring time, determining whether the measured time is a predetermined time, generating a screen image by using the data stored in the first data storage section when it is determined that the time is a predetermined time, and storing the generated screen image in a second storage section.

### ADVANTAGES OF THE INVENTION

According to the data processing apparatus of the invention, the latest program guide can instantly be displayed from the power off state by operating a specific button, so that the user can browse the program guide and program the timer recording without frustration.

### BRIEF DESCRIPTION OF DRAWINGS

FIG. 1 is a view showing a configuration of a screen image information output apparatus according to the embodiment of the invention.

FIG. 2 is a view showing an example of an input device (remote control).

FIG. 3 is a view showing another configuration of the screen image information output apparatus of the invention.

FIG. 4 is a view showing a display example of a program on a display device by the screen image information output apparatus.

FIG. 5 is a view showing a display example of a program guide.

FIG. 6 is a view showing another display example of the program guide.

FIG. 7 is a flowchart showing a process executed by the screen image information output apparatus when an instruction is received from the input device.

FIG. 8 is a flowchart showing a process executed by the screen image information output apparatus when power off is requested.

FIG. 9 is a flowchart showing a process executed by the screen image information output apparatus during power off state.

FIG. 10 is a flowchart showing a process executed by the screen image information output apparatus when power on is requested.

FIG. 11 is a flowchart showing a process executed by the screen image information output apparatus when display of a program guide is requested.

### REFERENCE NUMERALS

1 screen image information output apparatus (data processing apparatus)
10 display device
20 screen image selector
30 power controller
40 input device
50 display buffer
60 program guide controller
70 time measurement section
75 program guide data obtaining section
80 program guide data storage section
90 screen image processor
100 recording controller
110 communication interface
150 recording and reproducing apparatus

### BEST MODE FOR CARRYING OUT THE INVENTION

An embodiment of a data processing apparatus according to the invention will be described below using an example of a screen image information output apparatus with reference to the accompanying drawings. In the following description, the term “program guide” corresponds to screen image of a program guide actually displayed on a display device, and the term “program guide data” means original data (program information) from which the program guide is generated.

### 1 Configuration

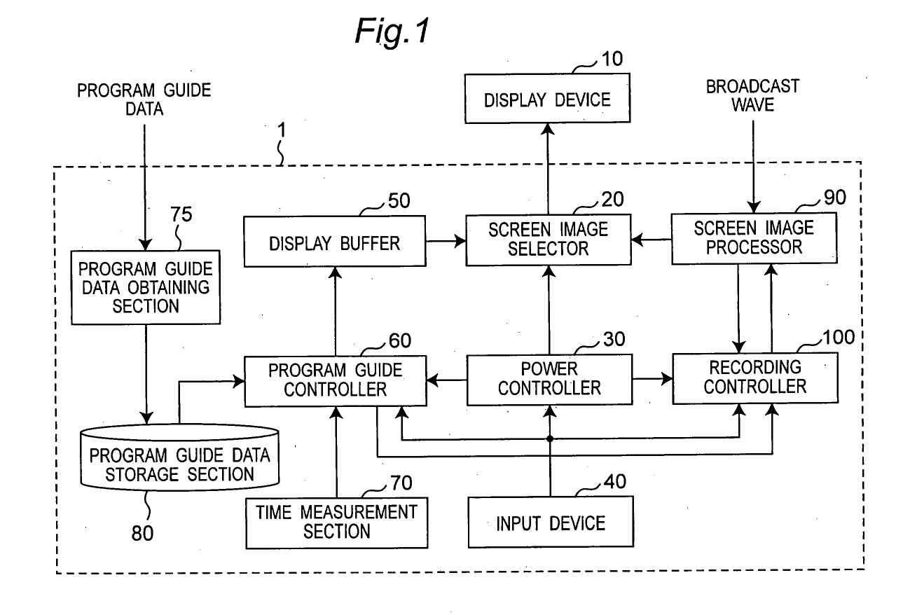

FIG. 1 is a view showing a configuration of a screen image information output apparatus according to an embodiment of the invention.

A screen image information output apparatus 1 includes a screen image selector 20, a power controller 30, an input device 40, a display buffer 50, a program guide controller 60, a time measurement section 70, a program guide data obtaining section 75, a program guide data storage section 80, a screen image processor 90, and a recording controller 100.

In the embodiment, it is assumed that the screen image information output apparatus 1 is a DVD recorder which can record a video signal in a recording medium such as DVD (Digital Versatile Disk) and HDD (Hard Disk Drive) and reproduce the recorded video signal. The screen image information output apparatus 1 can output the video signal to the display device 10.

The display device 10 is a device which can display a video signal, and, for example, the display device 10 is a television receiver or a monitor. The screen image selector 20 selectively outputs either a video signal from the screen image processor 90 or a video signal from the display buffer 50 to the display device 10. Alternately, the screen image selector 20 may superpose a video signal from the screen image processor 90 and a video signal from the display buffer 50 to output the superposed signals to the display device 10, if necessary. The power controller 30 performs management and control of power state of the screen image information output apparatus 1.

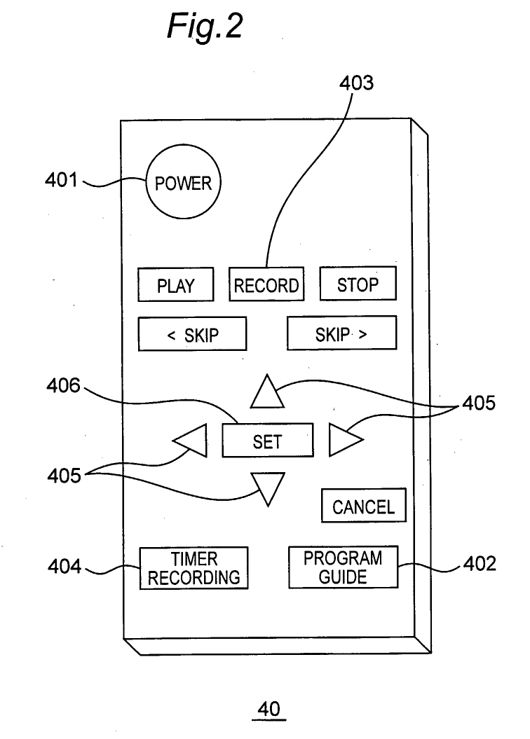

The input device 40 is a device which can input various operation instructions performed by the user. In the embodiment, the input device 40 is a remote control which can remotely operate the screen image information output apparatus 1. Instead of the remote control which performs remote operation, an operation panel incorporated in the screen image information output apparatus may be used. FIG. 2 shows a configuration of the input device 40 (remote control). The input device 40 has various buttons 401, 402, . . . . A power button 401 is a button for turning on or off the power of the screen image information output apparatus. A program guide button 402 is a button for displaying a program guide on the display device 10. A recording button 403 is a button for starting the recording of the program being received. A timer recording button 404 is a button for starting timer recording. Upward-and-downward and rightward-and-leftward selection buttons 405 are buttons for selecting a desired item in user setting and selection.

Returning to FIG. 1, the display buffer 50 is means in which graphic information to be displayed on the display device 10 is stored, and is composed of video RAM and the like. In the embodiment, at least the program guide is stored in the display buffer 50 under control of the program guide controller 60.

The program guide controller 60 performs control of the program guide in various ways while generating the program guide based on program guide data transmitted from a broadcast wave or the Internet. The time measurement section 70 measures real time.

The program guide data obtaining section 75 obtains the program guide data from a broadcast signal or the Internet at a predetermined timing.

The program guide data storage section 80 includes a storage device such as a non-volatile memory, and stores the program guide data obtained by the program guide data obtaining section 75. The screen image processor 90 processes the signals input to the screen image information output apparatus through an antenna and a tuner, and outputs video signals.

It is assumed that the program guide data storage section 80 always holds program data for one week from the current time. It is noted that the program data holding period is not limited to one week. It can be thought that the source of the screen image output from the screen image processor 90 is one that is decoded from a broadcasting signal of analog broadcasting or digital broadcasting. Although the display buffer 50 is used for displaying the program guide, the display buffer 50 may be used for displaying other information (for example, menu screen or apparatus status display, or setting screen).

The recording controller 100 performs recording of a video signal or timer recording, and includes a recording medium such as HDD for recording a video signal, a recording section which accesses the recording medium, and a controller which controls recording operation or timer recording for the recording section.

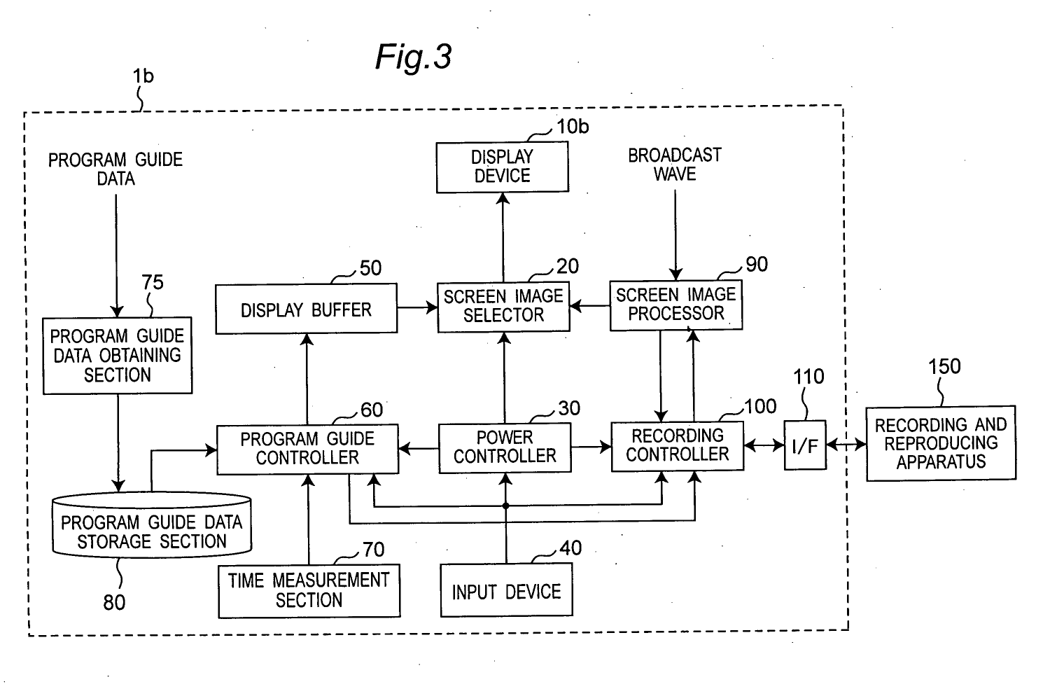

The screen image information output apparatus is not limited to a DVD recorder, but it may be a television receiver. FIG. 3 shows a configuration in which a screen image information output apparatus is a television receiver. A screen image information output apparatus 1b shown in FIG. 3 includes a display device 10b which is a CRT display or LCD (liquid crystal display) capable of displaying video signals. The recording controller 100 transmits recording control signals including setting information concerning video recording or timer recording, to a recording and reproducing apparatus 150 such as a DVD recorder through a communication interface 110. The communication interface 110 communicates with the recording and reproducing apparatus 150 through infrared communication or the like.

In other words, the screen image information output apparatus according to the invention may be an apparatus having a function of displaying a program guide in itself or a function of outputting a program guide information for displaying the program guide in an external device. The screen image information output apparatus may include a video cassette recorder, a personal computer, and the like.

### 2 Operation

An operation of the screen image information output apparatus 1 having the above-described configuration will be described below. It should be noted that in the screen image information output apparatus 1 of the invention, electric conduction is not completely cut off during power off of the apparatus main body, but the apparatus keeps energized and continuously operating in a standby state. That is, in the screen image information output apparatus 1 of the embodiment, power off state means standby state.

### 2.1 Screen Display

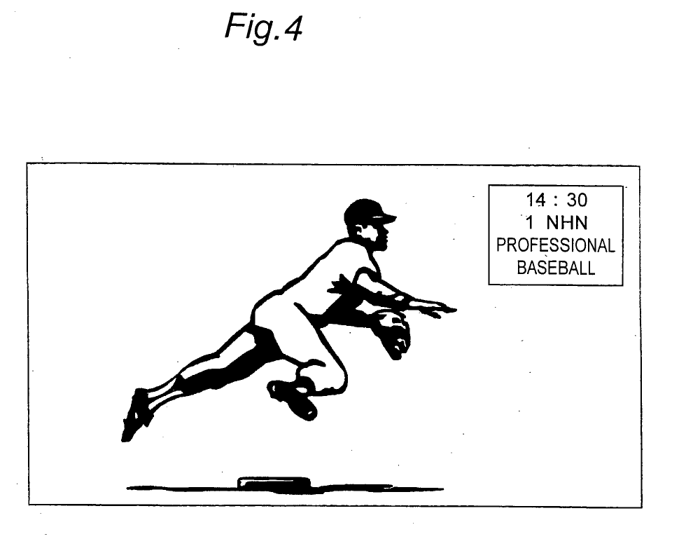

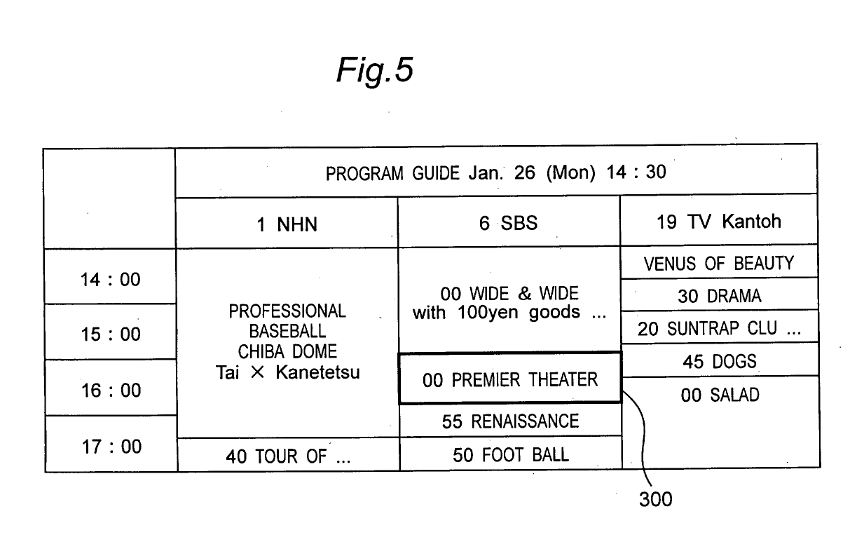

The screen image information output apparatus 1 can display a screen image of received broadcasting shown in FIG. 4 or a program guide shown in FIG. 5 on the display device 10. When the screen image selector 20 selects the video signal from the screen image processor 90, the screen image shown in FIG. 4 is displayed on the display device 10. When the screen image selector 20 selects the video signal stored in the display buffer 50, the program guide of FIG. 5 is displayed on the display device 10. The video signal stored in the display buffer 50 is generated by the program guide controller 60 based on the program guide data stored in the display data storage section 80.

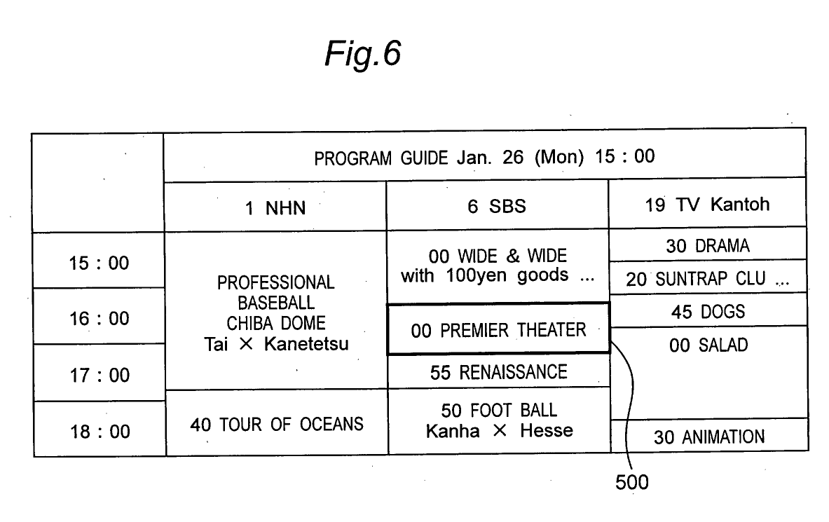

In this embodiment, as shown in FIG. 5, the program guide displays the program information having four hours in a longitudinal direction and three broadcasting stations in a crosswise direction. The program information is updated every hour (every hour 0 minute after the hour), and can scroll in a vertical direction. FIG. 5 shows a display example of the program guide displayed at time of 14:30. At 14:30, the program guide from fourteen to seventeen is displayed at one time. The program can be selected on the program guide by the upward-and-downward and rightward-and-leftward selection keys 405, and a selection frame 300 in FIG. 5 is moved within the program guide in conjunction with the operation of the selection keys 405. The method of displaying the program guide is not limited to a table format relating the broadcasting station to the time, but various methods can be used. For example, programs of only one broadcasting station may be displayed. Any method of displaying the program information can be used as long as a program guide is displayed. FIG. 6 shows a display example of the program guide displayed at time of 15:00.

### 2.2 Operation Flow

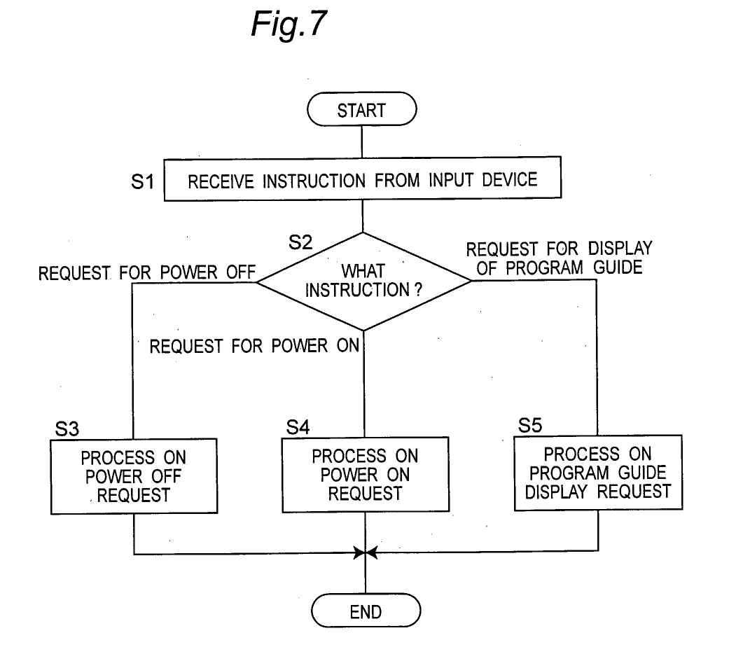

FIG. 7 is a view showing a flow of process to be executed when an instruction for requesting a process by predetermined buttons of the input device 40 in the screen image information output apparatus 1 of the embodiment. FIG. 7 shows processes for a request for power on/off by the power button 401 and a request for display of a program guide by the program guide button 402.

When receiving an instruction from the input device 40 (S1), the screen image information output apparatus 1 executes a process according to kind of the instruction (S2 to S5). When the instruction is a request for turning off the power of the screen image information output apparatus 1, the apparatus 1 executes a process on power off request for bringing the apparatus 1 from a power on state to a power off state (S3). When the instruction is a request for turning on the power of the screen image information output apparatus 1, the apparatus 1 executes a process on power on request for bringing the apparatus 1 from a power off state to a power on state (S4). When the instruction is a request for displaying the program guide, the apparatus 1 executes a process executed on request for displaying a program guide (S5). Each process (S3 to S5) will be described in detail later.

In step S2, the kind of the instruction can be determined based on a kind of the button pressed in the input device 40 and the power state of the screen image information output apparatus 1 at the time on request.

For example, when the power button 401 of the input device 40 is pressed while the screen image information output apparatus 1 is in power on state, the instruction can be determined to be a request for power off (that is, standby) of the apparatus 1. On the other hand, when the power button 401 of the input device 40 is pressed while the screen image information output apparatus 1 is in power off state, the instruction can be determined to be a request for power on of the apparatus 1. When the program guide button 402 of the input device 40 is pressed, the instruction can be determined to be a request for displaying a program guide.

2.3 Process on Power Off Request

The details of the process on power off request (Step S3) in the flowchart of FIG. 7 will be described.

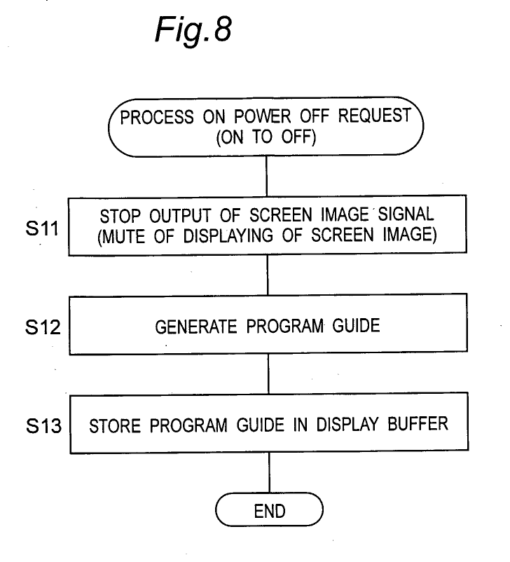

When the power button 401 of the input device 40 is pressed and thus the power controller 30 receives an instruction to switch the power, the power controller 30 starts the process on power off request (S3) if the screen image information output apparatus 1 is in “power on” state at that moment. FIG. 8 shows a flow of the process on power off request.

The power controller 30 controls selecting state of the screen image on the screen image selector 20 to cause the screen image of the display buffer 50 and the screen image of the screen image processor 90 not to be displayed (S11). That is, the screen image selector 20 stops the output of the video signal to the display device 10 (this process is referred to as “mute of screen image display”). This allows the display device 10 not to display any screen image. Since the screen becomes black while no video signal is displayed in the power off state of the display device 10, the power of the apparatus seems to be off by the user. In this embodiment, “turning off power” means to simply stop transmission of the video signal to the display device 10.

Then, the power controller 30 issues an instruction to the program guide controller 60 to generate the latest program guide (S12). The program guide controller 60 obtains current time information from the time measurement section 70 to generate the program guide corresponding to the current time. The program guide controller 60 generates the program guide based on the program guide data stored in the program guide data storage section 80, and stores the generated program guide in the display buffer 50 (S13). The program guide to be generated is for one week from the current time.

### 2.3.1 Process During Power Off State

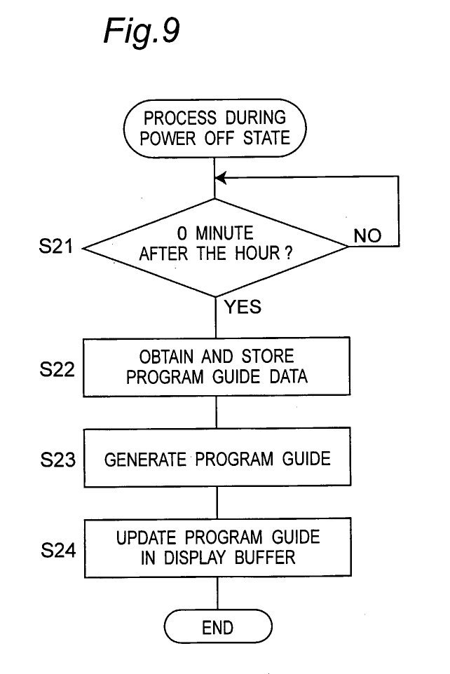

With reference to FIG. 9, the process executed while the screen image information output apparatus 1 is in the power off state will be described.

During the power off state, the program guide controller 60 refers to the time information from the time measurement section 70. Every hour 0 minute after the hour (S21), the program guide controller 60 obtains the latest program guide data from the broadcast wave, the Internet, and the like to store the program guide data in the program guide data storage section 80 (S22). The program guide controller 60 re-produces the program guide based on the obtained program guide data (S23), and updates the program guide stored in the display buffer 50 (S24). Therefore, the display buffer 50 always holds the program guide which is automatically updated to the latest one at the hour. In the embodiment, although the program guide is updated at the hour, the program guide may be updated at another time.

The result of updating process of the program guide display will be described with reference to FIGS. 5 and 6. The program guide display at 15:00 is shown in FIG. 6 and it is scrolled by one hour compared with the state shown in FIG. 5. FIGS. 5 and 6 show imagery if the program guide would be displayed. As described above, since the program guide is not displayed on the display device 10 while the apparatus is off, actually the user cannot visually recognize the program guide.

### 2.4 Process on Power on Request

The details of the process on power on request (S4) in the flowchart of FIG. 7 will be described.

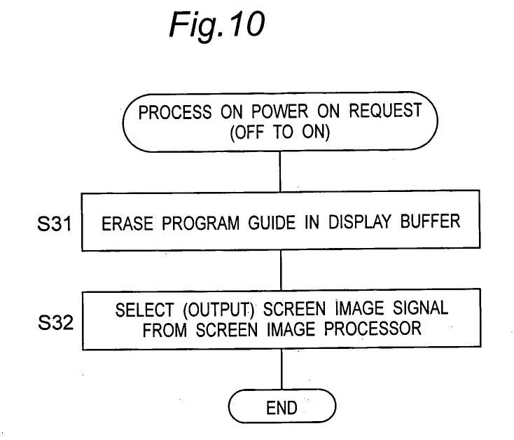

When the power button 401 of the input device 40 is pressed and thus the power controller 30 receives an instruction to switch the power, the power controller 30 starts the process on power on request (S4) if the screen image information output apparatus 1 is in “power off” state at that moment. FIG. 10 shows a flow of the process on power on request.

The power controller 30 requests the program guide controller 60 to erase the program guide. The program guide controller 60 erases the program guide stored in the display buffer 50 (S31), and notifies the power controller 30 of the completion of the erase after the erase is completed.

After the program guide controller 60 erases the program guide, the power controller 30 issues an instruction to the screen image selector 20 to select the video signal from the screen image processor 90 (S32). The screen image selector 20 selects the video signal from the screen image processor 90 to output the video signal to the is display device 10. As a result, as shown in FIG. 2, the screen image received through the antenna is displayed on the display device 10, and the screen image information output apparatus 1 is brought to on state.

### 2.5 Process on Program Guide Display Request

The details of process on program guide display request (S5) in the flowchart of FIG. 7 will be described.

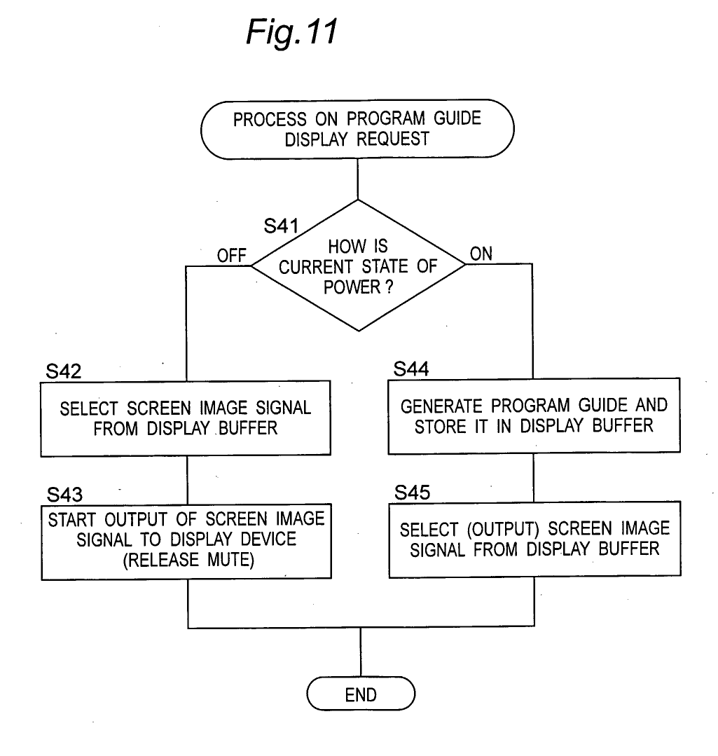

When the program guide button 402 of the input device 40 is pressed and thus the power controller 30 receives an instruction for display of the program guide, the power controller 30 executes the process of displaying the program guide on the display device 10. FIG. 11 shows a flow of the process on program guide display request.

When the program guide display instruction is issued from the input device 40, as shown in FIG. 1, the power controller 30 determines the power state of the screen image information output apparatus 1 (S41). When the screen image information output apparatus 1 is in the power off state at that time, the power controller 30 executes a process of transferring the screen image information output apparatus 1 to power on state and a process of displaying the program guide.

In the process of transferring to the power on state, the power controller 30 issues an instruction to the screen image selector 20 to select the display of the display buffer 50 (S42). At this time, since the screen image information output apparatus 1 is in power off state, the screen image selector 20 keeps stopping (mutes) the output of the video signal to the display device 10. According to the instruction from the power controller 30, the screen image selector 20 inputs the program guide stored in the display buffer 50, and outputs the input program guide to the display device 10 (namely, release the mute) (S43). The display device 10 displays the program guide transmitted from the screen image selector 20 on the screen. As a result, as shown in FIG. 5, the program guide is displayed on the display device 10, and the screen image information output apparatus 1 is brought to on state. Hence, when the program guide is requested to be display in the power off state, the program guide in the display buffer 50 which is prepared during the power off state can instantly be output to the display device 10, and thus the program guide can be displayed on the display device 10 in a short period of time. Therefore, the user does not have to wait for a long time till the program guide is displayed, and a comfortable operation environment is achieved.

On the other hand, when the screen image information output apparatus 1 is determined to be in “power on” state (S41), the power controller 30 controls the program guide controller 60 and the screen image selector 20 as follows.

The program guide controller 60 generates the program guide based on the program information stored in the program guide data storage section 80 and stores the generated program guide in the display buffer 50 (S44). Then, the screen image selector 20 selects the video signal of the display buffer 50 to output the selected video signal to the display device 10 (S45), allowing the program guide stored in the display buffer 50 to be displayed on the display device 10. Thus, when the program guide display is requested while the screen image information output apparatus 1 is in “power on” state, the latest program guide is generated at that time, and the generated program guide is displayed.

2.6 Recording and Timer Recording Processes

When the timer recording button 404 of the input device 40 is pressed with the program guide shown in FIG. 5 or 6 displayed on the display device 10, the program guide controller 60 is notified of a program recording instruction. The program guide controller 60 transmits a timer recording command for the program selected on the program guide to the recording controller 100. The recording controller 100 sets the timer recording of the selected program according to the program recording command.

Then, at the recording time that has been set in the timer recording, the recording controller 100 controls the screen image processor 90 so as to select a channel to which the timer recording is set. The recording controller 100 receives the video signal of the channel selected by the screen image processor 90, and records the video signal in the recording medium. In the example of FIG. 5, “PREMIER THEATER” of the broadcasting station “6SBS” is programmed.

When the recording button 403 of the input device 40 is pressed with the program guide shown in FIG. 5 or 6 displayed on the display device 10, the program guide controller 60 is notified of a recording instruction. The program guide controller 60 transmits a recording command for the selected broadcasting station to the recording controller 100.

The recording controller 100 inputs the video signal of the program being broadcasted of the selected broadcasting station from the screen image processor 90, and records the video signal in the recording medium. In the example of FIG. 5, “WIDE & WIDE” which is currently being broadcasted in the broadcasting station “6SBS” is recorded.

The recording operation instruction is performed by the recording button 403 of the input device 40 in the embodiment. Alternately, the currently selected program and broadcasting station may be specified by pressing the set button 406 of the input device 40. Since the recording or timer recording operation method is well known as functions of the conventional video cassette recorder or DVD recorder, the description will be omitted here.

### 3 Conclusion

As described above, according to the screen image information output apparatus of the embodiment, during power off state of the apparatus, the screen image output to the display device is stopped thus allowing the screen image information output apparatus to seem to be in power off state, and further the latest program guide is always stored. Therefore, when display of the program guide is requested during the power off state, the program guide can be displayed promptly on the display device.

### INDUSTRIAL APPLICABILITY

The present invention can be applied to apparatus which can display the program guide (EPG) available from the broadcasting or the Internet. The application of the present invention covers not only recording and reproducing devices such as a DVD recorder and screen image display devices such as a television receiver, but also devices at least having a function of display the electronic program guide.

Although the present invention has been described in connection with specified embodiments thereof, many other modifications, corrections and applications are apparent to those skilled in the art. Therefore, the present invention is not limited by the disclosure provided herein but limited only to the scope of the appended claims.

The present disclosure relates to subject matter contained in Japanese Patent Application No. 2004-372805, filed on Dec. 24, 2004, which is expressly incorporated herein by reference in its entirety.

1. A data processing apparatus for generating a screen image comprising:
an obtaining section operable to obtain externally data for generating a screen image;
a first data storage section operable to store the obtained data;
a determination section operable to determine whether a request for power on or standby of the apparatus is issued to the apparatus;
a generation section operable to generate a screen image by using the data stored in the first data storage section when it is determined by the determination section that the request for standby of the apparatus is issued; and
a second storage section operable to store the screen image generated by the generation section.

2. A data processing apparatus for generating a screen image comprising:
an obtaining section operable to obtain externally data for generating a screen image;
a first data storage section operable to store the obtained data;
a measurement section operable to measure time;
a determination section operable to determine whether the time measured by the measurement section is a predetermined time or not;
a generation section operable to generate a screen image by using the data stored in the first data storage section when it is determined by the determination section that the time is a predetermined time; and
a second storage section operable to store the screen image generated by the generation section.

3. The data processing apparatus according to claim 1 further comprising:
a display device operable to display the screen image;
a second determination section operable to determine whether a request for display of screen image is issued to the apparatus;
a third determination section operable to determine power state of the apparatus when it is determined by the second determination section that the request for display of screen image is issued; and
a controller operable to display, on the display device, the screen image stored in the second storage section when it is determined by the third determination section that the power state of the apparatus is standby state.

4. The data processing apparatus according to claim 3, wherein the controller erases the screen image stored in the second data storage section when it is determined by the first determination section that the request for power on of the apparatus is issued.

5. The data processing apparatus according to claim 1, wherein the data stored in the first storage section is data for generating a program guide.

6. The data processing apparatus according to claim 3, wherein the data stored in the first storage section is data for generating a program guide.

7. A data processing method for an apparatus for generating a screen image, the data processing method comprising:
obtaining externally data for generating a screen image;
storing the obtained data in a first storage section;
determining whether a request for power on or standby of the apparatus is issued to the apparatus or not;
generating a screen image by using the data stored in the first data storage section when it is determined that the request for standby of the apparatus is issued; and
storing the generated screen image in a second storage section.

8. A data processing method for an apparatus for generating a screen image, the data processing method comprising:
obtaining externally data for generating a screen image;
storing the obtained data in a first data storage section;
measuring time;
determining whether the measured time is a predetermined time;
generating a screen image by using the data stored in the first data storage section when it is determined that the time is a predetermined time; and
storing the generated screen image in a second storage section.

9. The data processing method according to claim 7 further comprising:
determining whether a request for display of screen image is issued to the apparatus;
determining power state of the apparatus when it is determined that the request for display of screen image is issued; and
displaying the screen image stored in the second storage section when it is determined that the power state of the apparatus is standby state.

10. The data processing apparatus according to claim 2 further comprising:
a display device operable to display the screen image;
a second determination section operable to determine whether a request for display of screen image is issued to the apparatus;
a third determination section operable to determine power state of the apparatus when it is determined by the second determination section that the request for display of screen image is issued; and
a controller operable to display, on the display device, the screen image stored in the second storage section when it is determined by the third determination section that the power state of the apparatus is standby state.

11. The data processing apparatus according to claim 10, wherein the controller erases the screen image stored in the second data storage section when it is determined by the first determination section that the request for power on of the apparatus is issued.

12. The data processing apparatus according to claim 2, wherein the data stored in the first storage section is data for generating a program guide.

13. The data processing apparatus according to claim 10, wherein the data stored in the first storage section is data for generating a program guide.

14. The data processing method according to claim 8 further comprising:
determining whether a request for display of screen image is issued to the apparatus;
determining power state of the apparatus when it is determined that the request for display of screen image is issued; and
displaying the screen image stored in the second storage section when it is determined that the power state of the apparatus is standby state.
